(19) United States
(12) Patent Application Publication
(10) Pub. No.: US 2022/0084502 A1
(43) Pub. Date: Mar. 17, 2022

(54) METHOD AND APPARATUS FOR DETERMINING SHAPE OF LIPS OF VIRTUAL CHARACTER, DEVICE AND COMPUTER STORAGE MEDIUM

(71) Applicant: Beijing Baidu Netcom Science and Technology Co., Ltd., Beijing (CN)

(72) Inventors: Mingming Ma, Beijing (CN); Tianshu Hu, Beijing (CN); Zhibin Hong, Beijing (CN)

(21) Appl. No.: 17/205,624

(22) Filed: Mar. 18, 2021

(30) Foreign Application Priority Data
Sep. 14, 2020 (CN) CN2020109629955

(51) Int. Cl. G10L 15/02; G10L 15/25; G10L 15/06; G10L 25/30

(52) U.S. Cl. CPC G10L 15/02; G10L 15/25; G10L 2015/025; G10L 25/30; G10L 15/063

(57) ABSTRACT

The present application discloses a method and apparatus for determining the shape of the lips of a virtual character, a device and a computer storage medium, and relates to an artificial intelligence technology, and particularly to computer vision and deep learning technologies. An implementation includes: determining a phoneme sequence corresponding to a voice, the phoneme sequence including a phoneme corresponding to each time point; determining lip-shape key point information corresponding to each phoneme in the phoneme sequence; searching a pre-established lip shape library according to each piece of determined lip-shape key point information, so as to obtain a lip shape image of each phoneme; and corresponding the searched lip shape image of each phoneme with each time point to obtain a lip-shape image sequence corresponding to the voice. With the present application, the voice may be synchronized with the shapes of the lips in the images.

The present application claims the priority of Chinese Patent Application No. 202010962995.5, filed on Sep. 14, 2020, with the title of “Method and apparatus for determining shape of lips of virtual character, device and computer readable storage medium”. The disclosure of the above application is incorporated herein by reference in its entirety.

### FIELD OF THE DISCLOSURE

The present application relates to an artificial intelligence technology, and particularly to computer vision and deep learning technologies.

### BACKGROUND OF THE DISCLOSURE

A virtual character refers to a fictional character existing in an authoring type video. With the rapid development of a computer technology, there emerge applications using the virtual character, such as news broadcast, a weather forecast, teaching, match commentary, intelligent interaction, or the like. Synthesis of a virtual character video involves two parts of data: a voice and an image containing the shape of the lips. However, during actual synthesis, how to guarantee synchronization between the voice and the shape of the lips in the image becomes a problem.

### SUMMARY OF THE DISCLOSURE

In view of this, the present application provides a method and apparatus for determining the shape of the lips of a virtual character, a device and a computer storage medium, so as to realize synchronization between a voice and the shape of the lips in an image.

In a first aspect, the present application provides a method for determining the shape of the lips of a virtual character, including:

determining a phoneme sequence corresponding to a voice, the phoneme sequence including a phoneme corresponding to each time point;

determining lip-shape key point information corresponding to each phoneme in the phoneme sequence;

searching a pre-established lip shape library according to each piece of determined lip-shape key point information, so as to obtain a lip shape image of each phoneme; and

corresponding the searched lip shape image of each phoneme with each time point to obtain a lip-shape image sequence corresponding to the voice.

In a second aspect, the present application provides an electronic device, comprising:

at least one processor; and

a memory communicatively connected with the at least one processor;

wherein the memory stores instructions executable by the at least one processor, and the instructions are executed by the at least one processor to enable the at least one processor to perform a method for determining the shape of the lips of a virtual character, wherein the method comprises:

determining a phoneme sequence corresponding to a voice, the phoneme sequence including a phoneme corresponding to each time point;

determining lip-shape key point information corresponding to each phoneme in the phoneme sequence;

searching a pre-established lip shape library according to each piece of determined lip-shape key point information, so as to obtain a lip shape image of each phoneme; and

corresponding the searched lip shape image of each phoneme with each time point to obtain a lip-shape image sequence corresponding to the voice.

In a third aspect, the present application provides a non-transitory computer readable storage medium with computer instructions stored thereon, wherein the computer instructions are used for causing a computer to perform a method for determining the shape of the lips of a virtual character, wherein comprises:

determining a phoneme sequence corresponding to a voice, the phoneme sequence comprising a phoneme corresponding to each time point;

determining lip-shape key point information corresponding to each phoneme in the phoneme sequence;

searching a pre-established lip shape library according to each piece of determined lip-shape key point information, so as to obtain a lip shape image of each phoneme; and

corresponding the searched lip shape image of each phoneme with each time point to obtain a lip-shape image sequence corresponding to the voice.

One embodiment in the above-mentioned application has the following advantages or beneficial effects. After determination of the phoneme sequence corresponding to the voice, the pre-established lip shape library is searched using the lip-shape key point information of the phoneme corresponding to each time point, so as to obtain the lip shape image of each phoneme, and the voice and the shape of the lips are aligned and synchronized through each time point.

Other effects of the above-mentioned alternatives will be described below in conjunction with embodiments.

### BRIEF DESCRIPTION OF DRAWINGS

The drawings are used for better understanding the present solution and do not constitute a limitation of the present application. In the drawings:

FIG. 1 shows an exemplary system architecture to which an embodiment of the present disclosure may be applied;

FIG. 2 is a flow chart of a method for determining the shape of the lips of a virtual character according to an embodiment of the present application;

FIG. 3 is a detailed flow chart of the method according to the embodiment of the present application;

FIG. 4 is a structural diagram of an apparatus according to an embodiment of the present application; and

FIG. 5 is a block diagram of an electronic device configured to implement the embodiment of the present application.

### DETAILED DESCRIPTION OF PREFERRED EMBODIMENTS

The following part will illustrate exemplary embodiments of the present application with reference to the figures, including various details of the embodiments of the present application for a better understanding. The embodiments should be regarded only as exemplary ones. Therefore, those skilled in the art should appreciate that various changes or modifications can be made with respect to the embodiments described herein without departing from the scope and spirit of the present application. Similarly, for clarity and conciseness, the descriptions of the known functions and structures are omitted in the descriptions below.

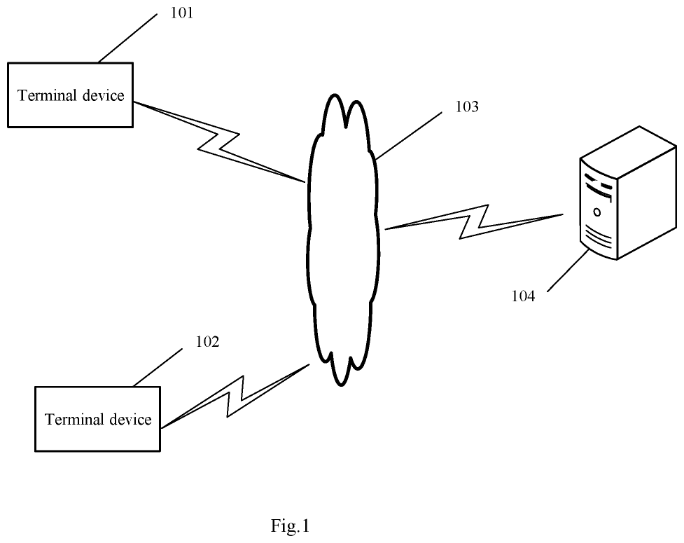

FIG. 1 shows an exemplary system architecture to which an apparatus for determining the shape of the lips of a virtual character according to an embodiment of the present disclosure may be applied.

As shown in FIG. 1, the system architecture may include terminal devices 101, 102, a network 103 and a server 104. The network 103 serves as a medium for providing communication links between the terminal devices 101, 102 and the server 104. The network 103 may include various connection types, such as wired and wireless communication links, or fiber-optic cables, or the like.

Users may use the terminal devices 101, 102 to interact with the server 104 through the network 103. Various applications, such as a voice interaction application, a media playing application, a web browser application, a communication application, or the like, may be installed on the terminal devices 101, 102.

The terminal devices 101, 102 may be configured as various electronic devices with screens, including, but not limited to, smart phones, tablets, personal computers (PC), smart televisions, or the like. The apparatus for determining the shape of the lips of a virtual character according to the present disclosure may be provided and run in the above-mentioned terminal device 101 or 102, or the above-mentioned server 104. The apparatus may be implemented as a plurality of pieces of software or software modules (for example, for providing distributed service), or a single piece of software or software module, which is not limited specifically herein.

For example, the apparatus for determining the shape of the lips of a virtual character is provided and run in the above-mentioned terminal device 101, and the terminal device acquires a voice from the server (the voice may be a voice obtained by performing voice synthesis on a text by the server, or a voice which corresponds to a text and is obtained by querying a voice library with the text by the server), or performs voice synthesis on the text locally to obtain the voice, or the terminal device queries the voice library with the text to obtain the voice corresponding to the text; then, a lip shape image corresponding to each time point of the voice is determined with a method according to an embodiment of the present application. The terminal device 101 may subsequently synthesize the voice and the lip shape image corresponding to each time point to obtain a virtual character video corresponding to the voice, and play the virtual character video.

As another example, the apparatus for determining the shape of the lips of a virtual character is provided and run in the above-mentioned server 104. The server may perform voice synthesis on the text to obtain the voice, or query the voice library with the text to obtain the corresponding voice. Then, the lip shape image corresponding to each time point of the voice is determined with the method according to the embodiment of the present application. The voice and the lip shape image corresponding to each time point of the voice are sent to and synthesized by the terminal device 101, so as to obtain the virtual character video corresponding to the voice, and the virtual character video is played.

As another example, the apparatus for determining the shape of the lips of a virtual character is provided and run in the above-mentioned server 104. The server may perform voice synthesis on the text to obtain the voice, or query the voice library with the text to obtain the corresponding voice. Then, the lip shape image corresponding to each time point of the voice is determined with the method according to the embodiment of the present application, the voice and the lip shape image corresponding to each time point are synthesized to obtain the virtual character video corresponding to the voice, and the virtual character video is sent to the terminal device. The terminal device plays the received virtual character video.

The server 104 may be configured as a single server or a server group including a plurality of servers. It should be understood that the numbers of the terminal devices, the network, and the server in FIG. 1 are merely schematic. There may be any number of terminal devices, networks and servers as desired for an implementation.

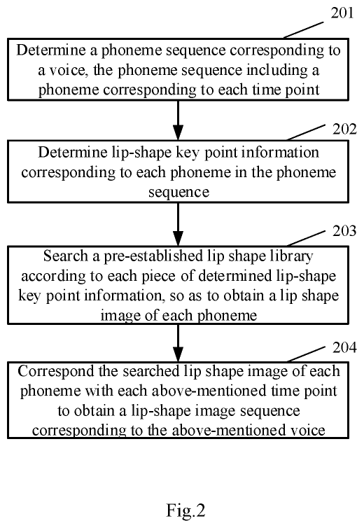

FIG. 2 is a flow chart of a method for determining the shape of the lips of a virtual character according to an embodiment of the present application, and as shown in FIG. 2, the method may include the following steps:

201: determining a phoneme sequence corresponding to a voice, the phoneme sequence including a phoneme corresponding to each time point.

The voice referred to in the present application may have different content in different application scenarios. For example, the voice corresponds to broadcast content in a broadcast scenario, such as news, a weather forecast, match commentary, or the like. For example, in an intelligent interaction scenario, the voice corresponds to a response text generated for a voice input by a user. Therefore, in most scenarios, the voice referred to in the present application is generated from a text. As a generation mechanism, the voice may be generated after real-time voice synthesis on the text, or the voice corresponding to the text may be obtained after a voice library is queried in real time with the text. The voice library is obtained by offline synthesizing or collecting various texts in advance.

As an implementation, the voice involved in this step may be a complete voice corresponding to a text, such as a broadcast text, a response text, or the like.

As another implementation, in order to reduce influences on the performance, the real-time performance, or the like, of a playing operation of a video by a terminal device, the voice may be spliced into a plurality of voice segments, and for each voice segment, a lip shape image is generated, and a virtual character video is synthesized. In this case, the voice involved in this step may be each above-mentioned voice segment.

Phonemes are the smallest language units divided according to natural attributes of a voice, and are the smallest units or smallest voice segments for making up a syllable. Phonemes may be labeled with different phonetic symbols depending on different languages. For example, for Chinese, pinyin may be used for the labeling operation. As an example, for the voice “ni hao a”, five corresponding phonemes include “n”, “i”, “h”, “ao” and “a”.

In this step, determining a phoneme sequence corresponding to a voice is actually determining the phoneme corresponding to each time point in this voice. Still taking the voice “ni hao a” as an example, each time point in this voice takes, for example, 10 ms as a step size, the first 10 ms and the second 10 ms correspond to the phoneme “n”, the third 10 ms, the fourth 10 ms and the fifth 10 ms correspond to the phoneme “i”, the sixth 10 ms is mute, the seventh 10 ms and the eighth 10 ms correspond to the phoneme “h”, and so on.

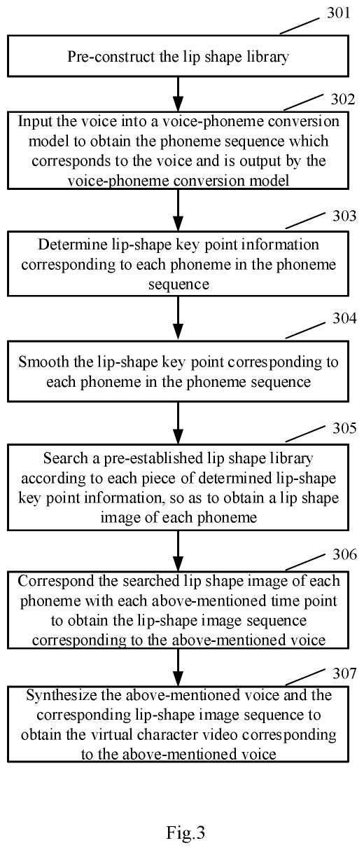

A specific implementation process will be described in detail in an embodiment shown in FIG. 3.

202: determining lip-shape key point information corresponding to each phoneme in the phoneme sequence.

In general, the shape of the lips may include a plurality of key points which are referred to as “lip-shape key points” in the present application and describe the contour of the shape of the lips. As an implementation, the key points may be distributed on the contour line of the shape of the lips. For example, 14 key points are adopted and distributed at two corners of the mouth, outer edges of the upper and lower lips, and edges of inner sides of the lips respectively. Other numbers of key points may be adopted in addition to this example.

The shape of the lips of a real person has a contour when the person makes each phoneme, and the contour may be characterized by specific lip-shape key point information. Due to the limited number of phonemes, the lip-shape key point information corresponding to each phoneme may be established and stored in advance, and may be obtained by a direct querying operation in this step. In addition, since the lip-shape key points have a fixed number and fixed positions at the lips, differences (for example, opening and closing degrees, shapes, or the like) between different shapes of the lips are mainly reflected on distances between the key points, and therefore, the lip-shape key point information referred to in the embodiment of the present application may include information of the distances between the key points.

203: searching a pre-established lip shape library according to each piece of determined lip-shape key point information, so as to obtain a lip shape image of each phoneme.

The lip shape library includes various lip shape images and lip-shape key point information corresponding to the lip shape images. Compared with a way of directly predicting the shape of the lips using a voice, the way of obtaining the lip shape image of each phoneme by searching the lip shape library has a higher speed and is able to effectively reduce influences on the performance of equipment. The process of creating the lip shape library and the search process will be described in detail in the following third embodiment.

204: corresponding the searched lip shape image of each phoneme with each above-mentioned time point to obtain a lip-shape image sequence corresponding to the above-mentioned voice.

Since the time points of the voice correspond to the phonemes in the phoneme sequence determined in the step 201, and the lip shape images determined in the step 203 also correspond to the phonemes, corresponding relationships between the time points of the voice and the lip shape images may be obtained, and the lip-shape image sequence corresponding to the voice is obtained according to the sequence of the time points.

FIG. 3 is a detailed flow chart of the method according to the embodiment of the present application, and as shown in FIG. 3, the method may include the following steps:

301: pre-constructing the lip shape library.

The lip shape library may be constructed manually; for example, various lip shape images are collected manually to cover the shapes of the lips of the phonemes as far as possible, and the key point information of each lip shape image is recorded.

As a preferred implementation, in order to reduce a labor cost, lip shape images of the real person in the speaking process may be collected in advance. For example, the lip shape images of the real person in the continuous speaking process are collected to cover the shapes of the lips of the phonemes as far as possible.

Then, the collected lip shape images are clustered based on the lip-shape key point information. For example, if the distances between the lip-shape key points are used as the lip-shape key point information, the lip shape images may be clustered based on the distances between the lip-shape key points, such that the images with similar distances between the lip-shape key points are clustered into one cluster, and the shapes of the lips in one cluster are similar.

One lip shape image and the lip-shape key point information corresponding to the lip shape image are selected from each cluster to construct the lip shape library. For example, the lip shape image at the center or a random lip shape image may be selected from each cluster.

302: inputting the voice into a voice-phoneme conversion model to obtain the phoneme sequence which corresponds to the voice and is output by the voice-phoneme conversion model.

This step is a preferred implementation of the step 201 in the embodiment shown in FIG. 2, and the voice-phoneme conversion (tts2phone) model may be pre-trained based on a recurrent neural network, such as a bidirectional long short-term memory (LSTM) with a variable length, a gated recurrent unit (GRU), or the like. The voice-phoneme conversion model has the function of outputting the phoneme sequence of the voice in the case of inputting the voice.

The process of pre-training the voice-phoneme conversion model may include: first acquiring training data including a voice sample and a phoneme sequence obtained by labeling the voice sample. The phoneme sequence may be obtained by labeling phonemes of the voice sample manually or by means of a dedicated labeling tool. Then, in the training process, the recurrent neural network is trained with the voice sample as input thereof and the phoneme sequence obtained by labeling the voice sample as target output thereof, so as to obtain the voice-phoneme conversion model. That is, the voice-phoneme conversion model has a training goal of minimizing the difference between the phoneme sequence output for the voice sample and the phoneme sequence labeled in the training sample.

In this embodiment, the phoneme sequence corresponding to the voice is obtained by the voice-phoneme conversion model obtained based on the recurrent neural network, and has high accuracy and speed.

Step 303 is the same as the step 202 in the embodiment shown in FIG. 2, and is not repeated herein.

304: smoothing the lip-shape key point corresponding to each phoneme in the phoneme sequence.

In this step, the lip-shape key point of each phoneme in the phoneme sequence is smoothed in a way which is not limited in the present application and may be implemented by interpolation, or the like.

This step is a preferred processing way in this embodiment, and is not necessary. This step has the aim that the shapes of the lips have natural transition without an obvious jump in the playing process of the virtual character video which is synthesized subsequently.

305: searching a pre-established lip shape library according to each piece of determined lip-shape key point information, so as to obtain a lip shape image of each phoneme.

Since the lip shape library includes various lip shape images and the lip-shape key point information corresponding to the lip shape images, the lip shape library may be searched utilizing each piece of lip-shape key point information determined in the previous step, so as to find the lip shape image corresponding to the lip-shape key point information which is most similar to each piece of lip-shape key point information as the lip shape image of each phoneme.

If the information of the distances between the key points is used as the above-mentioned lip-shape key point information, as an implementation, the information of the distance of each lip-shape key point corresponding to one phoneme may be represented as a vector, and the distance of each lip-shape key point corresponding to each lip shape image in the lip shape library may also be represented as a vector. Then, the lip shape library may be searched for match based on the match of the similarity between the vectors.

306: corresponding the searched lip shape image of each phoneme with each above-mentioned time point to obtain the lip-shape image sequence corresponding to the above-mentioned voice.

Since the time points of the voice correspond to the phonemes in the phoneme sequence determined in the step 302, and the lip shape images determined in the step 305 also correspond to the phonemes, corresponding relationships between the time points of the voice and the lip shape images may be obtained, and the lip-shape image sequence corresponding to the voice is obtained according to the sequence of the time points.

307: synthesizing the above-mentioned voice and the corresponding lip-shape image sequence to obtain the virtual character video corresponding to the above-mentioned voice.

After processing actions in the above-mentioned steps 301 to 306, the voice is aligned with the shape of the lips; that is, each time point of the voice has one corresponding lip shape image; therefore, the above-mentioned voice may be synthesized with the lip-shape image sequence corresponding to the voice to obtain the virtual character video. In the virtual character video, the played voice is aligned and synchronized with the shape of the lips in the image.

In the synthesis process, a background image may be extracted from a background library first. The background image contains a virtual character, a background, or the like. In the synthesis process, the background image at each time point may be the same, and then, the lip shape image is synthesized in the background image corresponding to each time point. In the video generated in this way, at each time point of the voice, the virtual character has the shape of the lips of the phoneme corresponding to this time point.

The method according to the present application is described above in detail, and an apparatus according to the present application will be described below in detail.

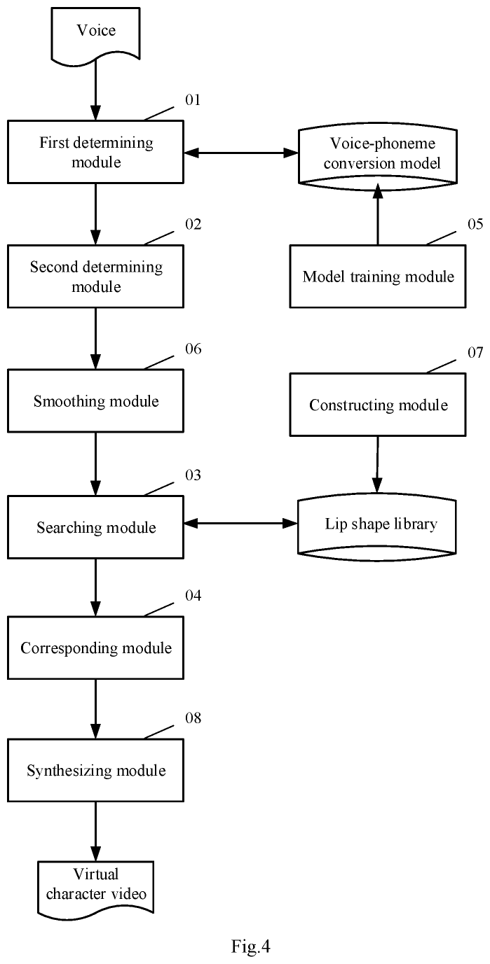

FIG. 4 is a structural diagram of an apparatus according to an embodiment of the present application; the apparatus may be configured as an application located at a terminal device, or a functional unit, such as a plug-in or software development kit (SDK) located in the application of the terminal device, or the like, or be located at a server, which is not particularly limited in the embodiment of the present disclosure. As shown in FIG. 4, the apparatus may include a first determining module 01, a second determining module 02, a searching module 03 and a corresponding module 04, and may further include a model training module 05, a smoothing module 06, a constructing module 07 and a synthesizing module 08. The main functions of each constitutional module are as follows.

The first determining module 01 is configured to determine a phoneme sequence corresponding to a voice, the phoneme sequence including a phoneme corresponding to each time point.

As an implementation, the voice involved in this step may be a complete voice corresponding to a text, such as a broadcast text, a response text, or the like.

As another implementation, in order to reduce influences on the performance, the real-time performance, or the like, of a playing operation of a video by a terminal device, the voice may be spliced into a plurality of voice segments, and for each voice segment, a lip shape image is generated, and a virtual character video is synthesized. In this case, the voice involved in this step may be each above-mentioned voice segment.

The first determining module 01 may input the voice into a voice-phoneme conversion model to obtain the phoneme sequence output by the voice-phoneme conversion model. The voice-phoneme conversion model is pre-trained based on a recurrent neutral network.

The second determining module 02 is configured to determine lip-shape key point information corresponding to each phoneme in the phoneme sequence.

The searching module 03 is configured to search a pre-established lip shape library according to each piece of determined lip-shape key point information, so as to obtain the lip shape image of each phoneme.

The corresponding module 04 is configured to correspond the searched lip shape image of each phoneme with each time point to obtain a lip-shape image sequence corresponding to the voice.

The model training module 05 is configured to acquire training data including a voice sample and a phoneme sequence obtained by labeling the voice sample; and train the recurrent neural network with the voice sample as input thereof and the phoneme sequence obtained by labeling the voice sample as target output thereof, so as to obtain the voice-phoneme conversion model.

The recurrent neural network may be configured as a bidirectional long short-term memory (LSTM) with a variable length, a gated recurrent unit (GRU), or the like.

The smoothing module 06 is configured to smooth the lip-shape key point which corresponds to each phoneme in the phoneme sequence and determined by the second determining module 02. Correspondingly, the searching module 03 performs the search based on the smoothed lip-shape key point information.

The lip shape library in this embodiment may include various lip shape images and lip-shape key point information corresponding to the lip shape images.

The lip shape library may be constructed manually; for example, various lip shape images are collected manually to cover the shapes of the lips of the phonemes as far as possible, and the key point information of each lip shape image is recorded.

As a preferred implementation, in order to reduce a labor cost, the constructing module 07 may collect lip shape images of a real person in the speaking process; cluster the collected lip shape images based on the lip-shape key point information; and select one lip shape image and the lip-shape key point information corresponding to the lip shape image from each cluster to construct the lip shape library.

The lip-shape key point information may include information of the distances between the key points.

The synthesizing module 08 is configured to synthesize the voice and the lip-shape image sequence corresponding to the voice to obtain the virtual character video corresponding to the voice.

According to the embodiment of the present application, there are also provided an electronic device and a readable storage medium.

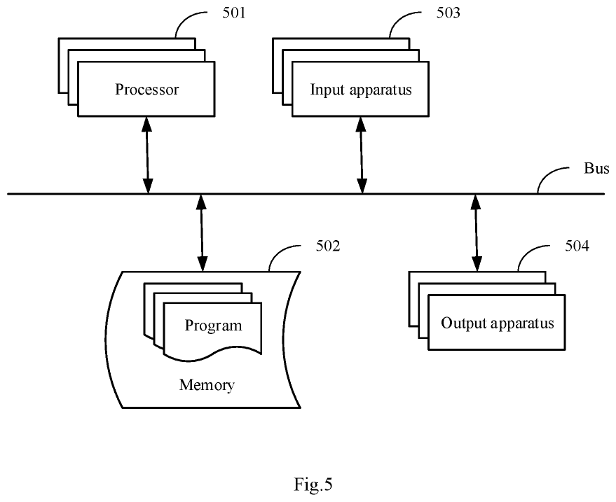

FIG. 5 is a block diagram of an electronic device for the method for determining the shape of the lips of a virtual character according to the embodiment of the present application. The electronic device is intended to represent various forms of digital computers, such as laptop computers, desktop computers, workstations, personal digital assistants, servers, blade servers, mainframe computers, and other appropriate computers. The electronic device may also represent various forms of mobile apparatuses, such as personal digital processors, cellular telephones, smart phones, wearable devices, and other similar computing apparatuses. The components shown herein, their connections and relationships, and their functions, are meant to be exemplary only, and are not meant to limit implementation of the present application described and/or claimed herein.

As shown in FIG. 5, the electronic device includes one or more processors 501, a memory 502, and interfaces configured to connect the components, including high-speed interfaces and low-speed interfaces. The components are interconnected using different buses and may be mounted at a common motherboard or in other manners as desired. The processor may process instructions for execution within the electronic device, including instructions stored in or at the memory to display graphical information for a GUI at an external input/output apparatus, such as a display device coupled to the interface. In other implementations, plural processors and/or plural buses may be used with plural memories, if desired. Also, plural electronic devices may be connected, with each device providing some of necessary operations (for example, as a server array, a group of blade servers, or a multi-processor system). In FIG. 5, one processor 501 is taken as an example.

The memory 502 is configured as the non-transitory computer readable storage medium according to the present application. The memory stores instructions executable by the at least one processor to cause the at least one processor to perform a method for determining the shape of the lips of a virtual character according to the present application. The non-transitory computer readable storage medium according to the present application stores computer instructions for causing a computer to perform the method for determining the shape of the lips of a virtual character according to the present application.

The memory 502 which is a non-transitory computer readable storage medium may be configured to store non-transitory software programs, non-transitory computer executable programs and modules, such as program instructions/modules corresponding to the method for determining the shape of the lips of a virtual character according to the embodiment of the present application. The processor 501 executes various functional applications and data processing of a server, that is, implements the method for determining the shape of the lips of a virtual character according to the above-mentioned embodiment, by running the non-transitory software programs, instructions, and modules stored in the memory 502.

The memory 502 may include a program storage area and a data storage area, wherein the program storage area may store an operating system and an application program required for at least one function; the data storage area may store data created according to use of the electronic device, or the like. Furthermore, the memory 502 may include a high-speed random access memory, or a non-transitory memory, such as at least one magnetic disk storage device, a flash memory device, or other non-transitory solid state storage devices. In some embodiments, optionally, the memory 502 may include memories remote from the processor 501, and such remote memories may be connected to the electronic device via a network. Examples of such a network include, but are not limited to, the Internet, intranets, local area networks, mobile communication networks, and combinations thereof.

The electronic device may further include an input apparatus 503 and an output apparatus 504. The processor 501, the memory 502, the input apparatus 503 and the output apparatus 504 may be connected by a bus or other means, and FIG. 5 takes the connection by a bus as an example.

The input apparatus 503 may receive input numeric or character information and generate key signal input related to user settings and function control of the electronic device, such as a touch screen, a keypad, a mouse, a track pad, a touch pad, a pointing stick, one or more mouse buttons, a trackball, a joystick, or the like. The output apparatus 504 may include a display device, an auxiliary lighting apparatus (for example, an LED) and a tactile feedback apparatus (for example, a vibrating motor), or the like. The display device may include, but is not limited to, a liquid crystal display (LCD), a light emitting diode (LED) display, and a plasma display. In some implementations, the display device may be a touch screen.

Various implementations of the systems and technologies described here may be implemented in digital electronic circuitry, integrated circuitry, application specific integrated circuits (ASIC), computer hardware, firmware, software, and/or combinations thereof. The systems and technologies may be implemented in one or more computer programs which are executable and/or interpretable on a programmable system including at least one programmable processor, and the programmable processor may be special or general, and may receive data and instructions from, and transmitting data and instructions to, a storage system, at least one input apparatus, and at least one output apparatus.

These computer programs (also known as programs, software, software applications, or codes) include machine instructions for a programmable processor, and may be implemented using high-level procedural and/or object-oriented programming languages, and/or assembly/machine languages. As used herein, the terms “machine readable medium” and “computer readable medium” refer to any computer program product, device and/or apparatus (for example, magnetic discs, optical disks, memories, programmable logic devices (PLD)) for providing machine instructions and/or data to a programmable processor, including a machine readable medium which receives machine instructions as a machine readable signal. The term “machine readable signal” refers to any signal for providing machine instructions and/or data to a programmable processor.

To provide interaction with a user, the systems and technologies described here may be implemented on a computer having: a display apparatus (for example, a cathode ray tube (CRT) or liquid crystal display (LCD) monitor) for displaying information to a user; and a keyboard and a pointing apparatus (for example, a mouse or a trackball) by which a user may provide input to the computer. Other kinds of apparatuses may also be used to provide interaction with a user; for example, feedback provided to a user may be any form of sensory feedback (for example, visual feedback, auditory feedback, or tactile feedback); and input from a user may be received in any form (including acoustic, voice or tactile input).

The systems and technologies described here may be implemented in a computing system (for example, as a data server) which includes a back-end component, or a computing system (for example, an application server) which includes a middleware component, or a computing system (for example, a user computer having a graphical user interface or a web browser through which a user may interact with an implementation of the systems and technologies described here) which includes a front-end component, or a computing system which includes any combination of such back-end, middleware, or front-end components. The components of the system may be interconnected through any form or medium of digital data communication (for example, a communication network). Examples of the communication network include: a local area network (LAN), a wide area network (WAN) and the Internet.

A computer system may include a client and a server. Generally, the client and the server are remote from each other and interact through the communication network. The relationship between the client and the server is generated by virtue of computer programs which run on respective computers and have a client-server relationship to each other.

It should be understood that various forms of the flows shown above may be used and reordered, and steps may be added or deleted. For example, the steps described in the present application may be executed in parallel, sequentially, or in different orders, which is not limited herein as long as the desired results of the technical solution disclosed in the present application may be achieved.

The above-mentioned implementations are not intended to limit the scope of the present application. It should be understood by those skilled in the art that various modifications, combinations, sub-combinations and substitutions may be made, depending on design requirements and other factors. Any modification, equivalent substitution and improvement made within the spirit and principle of the present application all should be included in the extent of protection of the present application.

What is claimed is:

1. A method for determining the shape of the lips of a virtual character, comprising:
determining a phoneme sequence corresponding to a voice, the phoneme sequence comprising a phoneme corresponding to each time point;
determining lip-shape key point information corresponding to each phoneme in the phoneme sequence;
searching a pre-established lip shape library according to each piece of determined lip-shape key point information, so as to obtain a lip shape image of each phoneme; and
corresponding the searched lip shape image of each phoneme with each time point to obtain a lip-shape image sequence corresponding to the voice.

2. The method according to claim 1, wherein the voice is voice data obtained by performing voice synthesis on a text; or
the voice is a voice segment obtained by splicing the voice data.

3. The method according to claim 1, wherein the determining a phoneme sequence corresponding to a voice comprises:
inputting the voice into a voice-phoneme conversion model to obtain the phoneme sequence output by the voice-phoneme conversion model;
the voice-phoneme conversion model is pre-trained based on a recurrent neutral network.

4. The method according to claim 3, wherein the voice-phoneme conversion model is pre-trained by:
acquiring training data comprising a voice sample and a phoneme sequence obtained by labeling the voice sample; and
training the recurrent neural network with the voice sample as input thereof and the phoneme sequence obtained by labeling the voice sample as target output thereof, so as to obtain the voice-phoneme conversion model.

5. The method according to claim 1, before the searching a pre-established lip shape library, further comprising:
smoothing a lip-shape key point corresponding to each phoneme in the phoneme sequence.

6. The method according to claim 1, wherein the lip shape library comprises various lip shape images and lip-shape key point information corresponding to the lip shape images.

7. The method according to claim 6, further comprising:
collecting lip shape images of a real person in the speaking process in advance;
clustering the collected lip shape images based on the lip-shape key point information; and
selecting one lip shape image and the lip-shape key point information corresponding to the lip shape image from each cluster to construct the lip shape library.

8. The method according to claim 1, wherein the lip-shape key point information comprises information of the distances between the key points.

9. The method according to claim 6, wherein the lip-shape key point information comprises information of the distances between the key points.

10. The method according to claim 7, wherein the lip-shape key point information comprises information of the distances between the key points.

11. The method according to claim 1, further comprising:
synthesizing the voice and the lip-shape image sequence corresponding to the voice to obtain a virtual character video corresponding to the voice.

12. An electronic device, comprising:
at least one processor; and
a memory communicatively connected with the at least one processor;
wherein the memory stores instructions executable by the at least one processor, and the instructions are executed by the at least one processor to enable the at least one processor to perform a method for determining the shape of the lips of a virtual character, wherein the method comprises:
determining a phoneme sequence corresponding to a voice, the phoneme sequence comprising a phoneme corresponding to each time point;
determining lip-shape key point information corresponding to each phoneme in the phoneme sequence;
searching a pre-established lip shape library according to each piece of determined lip-shape key point information, so as to obtain a lip shape image of each phoneme; and
corresponding the searched lip shape image of each phoneme with each time point to obtain a lip-shape image sequence corresponding to the voice.

13. The electronic device according to claim 12, wherein the voice is voice data obtained by performing voice synthesis on a text; or
the voice is a voice segment obtained by splicing the voice data.

14. The electronic device according to claim 12, wherein the determining a phoneme sequence corresponding to a voice comprises:
inputting the voice into a voice-phoneme conversion model to obtain the phoneme sequence output by the voice-phoneme conversion model;
the voice-phoneme conversion model is pre-trained based on a recurrent neutral network.

15. The electronic device according to claim 14, wherein the voice-phoneme conversion model is pre-trained by:
acquiring training data comprising a voice sample and a phoneme sequence obtained by labeling the voice sample; and
training the recurrent neural network with the voice sample as input thereof and the phoneme sequence obtained by labeling the voice sample as target output thereof, so as to obtain the voice-phoneme conversion model.

16. The electronic device according to claim 12, before the searching a pre-established lip shape library, further comprising:
smoothing a lip-shape key point corresponding to each phoneme in the phoneme sequence.

17. The electronic device according to claim 12, wherein the lip shape library comprises various lip shape images and lip-shape key point information corresponding to the lip shape images.

18. The electronic device according to claim 17, further comprising:
collecting lip shape images of a real person in the speaking process;
clustering the collected lip shape images based on the lip-shape key point information; and
selecting one lip shape image and the lip-shape key point information corresponding to the lip shape image from each cluster to construct the lip shape library.

19. The electronic device according to claim 12, wherein the lip-shape key point information comprises information of the distances between the key points.

20. A non-transitory computer readable storage medium with computer instructions stored thereon, wherein the computer instructions are used for causing a computer to perform a method for determining the shape of the lips of a virtual character, wherein the method comprises:
determining a phoneme sequence corresponding to a voice, the phoneme sequence comprising a phoneme corresponding to each time point;
determining lip-shape key point information corresponding to each phoneme in the phoneme sequence;
searching a pre-established lip shape library according to each piece of determined lip-shape key point information, so as to obtain a lip shape image of each phoneme; and
corresponding the searched lip shape image of each phoneme with each time point to obtain a lip-shape image sequence corresponding to the voice.
